(19) United States
(12) Patent Application Publication
(10) Pub. No.: US 2002/0141438 A1
(43) Pub. Date: Oct. 3, 2002

(54) Data communication controller and method

(76) Inventors: J. Howard Smith, Greenfield, WI (US); Michael B. Justice, Naperville, IL (US)

Correspondence Address: STETINA BRUNDA GARRED & BRUCKER, 75 ENTERPRISE, SUITE 250, ALISO VIEJO, CA, 92656, US

(21) Appl. No.: 09/780,979

(22) Filed: Feb. 9, 2001

(51) Int. Cl. H04L 12/28

(52) U.S. Cl. 370/465; 370/351

(57) ABSTRACT

A communication controller includes a memory circuit and a processor operable in response to data and instructions stored in the memory circuit. A first communication circuit is under control of the processor for communicating between the communication controller and a first remote device according to a first data communication standard. A second communication circuit is under control of the processor for communicating between the communication controller and a second remote device according to a second data communication standard. The second data communication standard is different from the first data communication standard.

### CROSS REFERENCE TO RELATED APPLICATIONS

This application is related to application Ser. No. 09/______, entitled DATA COMMUNICATION PRIORITIZATION METHOD AND BUS CONTROLLER, attorney docket number 10521/5, filed on the same date herewith and commonly assigned with the present application.

### BACKGROUND OF THE INVENTION

The present invention relates generally to a data communication controller and method. More particularly, the invention relates to a communication controller operable with a plurality of data communication standards and a method for data communication prioritization.

Data communication standards have been developed to facilitate data communication in a variety of environments. One transmitter sends data over one or more wires to one or more receivers. The transmitter and receivers use the same standard for encoding and formatting the data. This ensures reliable reception of the data by the intended receiver. Some known data communication standards include Ethernet, Controller Area Network (CAN), Serial Peripheral Interface (SPI), and ProfiBus. These are examples of field bus standards.

Field buses provide communication between distributed peripherals, such as input/output devices, measurement devices, drive units, valves and operator terminals. Such buses allow efficient, real time communication among an automation system.

Buses such as field buses include master and slave devices. Master devices determine the data communication on the bus. A master can send messages without an external request when it holds the bus access rights such as a token. Masters are also called active stations. Slave devices are peripherals such as I/O devices, valves, drives and measuring transducers. They do not have bus access rights and they can only acknowledge received messages or send messages to the master when requested to do so.

A master or slave device located on a bus employs a bus controller for communication according to the bus standard. The device generally includes a source or destination of data and the bus controller. Data sources include, for example, sensors which gather data. Data destinations include, for example, memory for storing the data. Examples for bus implementations include a factory and automotive installations.

In the past, it has been known to combine in a bus controller of a communication circuit for one data communications standard and a processor such as a microprocessor. Examples include a combined microprocessor and ProfiBus controller from Siemens AG and combined microprocessor CAN controller available from Motorola Inc. and Dallas Semiconductor Corp. The communication circuit provides wireline data communication according to the selected standard. The microprocessor provides control and other functionality.

However, as different systems are required to interchange data, new communication flexibility is required. For example, in an automobile factory, the factory equipment may use the ProfiBus standard and the automobiles themselves may use an on-board CAN bus. The factory equipment may be connected with separate equipment for data processing by means of an Ethernet bus. Thus, for collection of data by factory devices from the automobiles, two or more types of communication circuit or data translation are required.

Further, devices such as communication controllers are very cost sensitive. In consumer products such as automobiles, there is an important design goal to reduce overall product cost by reducing component costs. This is also true in other data communication environments such as factories or offices.

Still further, for the manufacturer of the data communication controllers, product costs may be reduced by producing large numbers of the devices. If design and manufacturing costs can be spread over more devices, the final product cost is decreased. This makes the product more profitable or more marketable inside to the system integrator.

Still further, it is known to provide for arbitration among transmitters when communicating on a data communication bus. In one example of the Controller Area Network (CAN) bus, whenever the bus is free, any unit may start to transmit a message. If two or more units start transmitting messages at the same time, the bus access conflict is resolved by bitwise arbitration using data in the message. The CAN arbitration guarantees that neither information nor time is lost. During arbitration, every transmitter compares the level of the bit transmitted with the level that is monitored on the bus. If these levels are equal, the unit may continue to send. When a recessive level is sent and a dominant level is monitored, the unit has lost arbitration and must withdraw, sending no more bits.

This example of arbitration is useful in a bus environment. However, a bus controller may have several messages waiting for transmission. It may be desirable to prioritize those messages before submitting them for transmission. Current bus controllers lack a convenient technique for achieving this prioritization.

Accordingly, there is a need for an improved data communication controller and improved methods for data communication.

### SUMMARY OF THE INVENTION

By way of introduction only, the present embodiments include a communication controller which includes a memory circuit and a processor operable in response to data and instructions stored in the memory circuit. The communication controller further includes a first communication circuit under control of the processor for communicating between the communication controller and a first remote device according to a first data communication standard. The communication controller still further includes a second communication circuit under control of the processor for communicating between the communication controller and a second remote device according to a second data communication standard. The second data communication standard is different from the first data communication standard.

The present embodiments further include a data communication device which includes first communication means for external communication according to a first standard network communication protocol and second communication means for external communication according to a second standard network communication protocol. The data communication device further includes processing means for data processing. The processing means includes communication control means for controlling operation of the first communication means and the second communication means.

The present embodiments further include an integrated circuit which includes a processor block which controls operation of the integrated circuit and a memory block which stores data and instructions for use by the processor block. The integrated circuit further includes a first data communication port and a ProfiBus block coupled with the first data communication port. The integrated circuit further includes a second data communication port and a Controller Area Network (CAN) control block coupled with the second data communication port. The integrated circuit still further includes an internal bus coupling the processor block, the memory block, the ProfiBus control block and the CAN control block.

The present embodiments still further include a ProfiBus controller which includes a ProfiBus core, a processor and a memory. The ProfiBus controller further includes at least one control circuit which controls wireline data communications according to a standard other than ProfiBus standard and an internal bus for internal data communications within the ProfiBus controller.

The foregoing discussion of illustrative embodiments of the invention has been provided only by way of introduction. Nothing in this section should be taken as a limitation on the following claims, which define the scope of the invention.

### BRIEF DESCRIPTION OF THE DRAWINGS

FIG. 1 is a block diagram of a communication controller;

FIG. 2 illustrates a prior art message format for use by the CAN controller of the communication controller of FIG. 1;

FIG. 3 is a detailed view of the CAN controller message protocol of FIG. 2;

FIG. 4 is a block diagram of a communication circuit for use in the communication controller of FIG. 1;

FIG. 5 is a flow diagram illustrating operation of the communication circuit of FIG. 4; and

FIG. 6 is a flow diagram illustrating operation of the communication circuit of FIG. 4.

### DETAILED DESCRIPTION OF THE PRESENTLY PREFERRED EMBODIMENTS

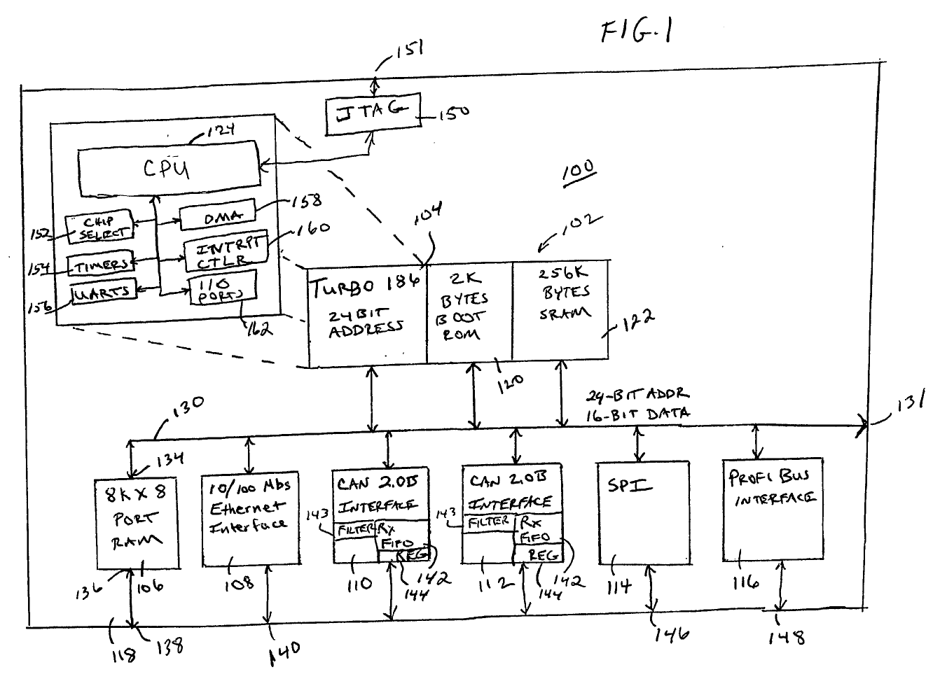

Referring now to the drawing, FIG. 1 is a block diagram of a communication controller 100. The communication controller 100 includes a memory circuit 102 and a processor 104. The communication controller 100 further includes a dual port memory 106, an Ethernet interface 108, a first Controller Area Network (CAN) communication circuit 110, a second CAN communication circuit 112, a Serial Peripheral Interface (SPI) communication circuit 114 and a ProfiBus communication controller 116.

An internal communication bus 130 couples the processor 104 and other components of the communication controller 100. In the illustrated embodiment, the internal communication bus includes a 24 bit address bus and a 16 bit data bus. Other bus configurations may be chosen, and the bus may include other signals lines such as control signal lines for communication among components of the communication controller 100. In the illustrated embodiment, the address and data signals are carried on respective address and data lines. In alternative embodiments, the address and data signals may be time shared on a single, suitably sized bus. In the illustrated embodiment, the address bus and the data bus are externally available by means of a port 131. The port 131 in one embodiment includes 40 or more pins of the integrated circuit.

In the illustrated embodiment, the communication controller is integrated in a single integrated circuit 118. In alternate embodiments, components of the communication controller 100 may be contained in separate circuit components and wired together for operability. In still other embodiments, subsets of the components of the communication controller 100 may be combined in one or more integrated circuits. However, combination of substantially all the components of the communication controller 100 in a single integrated circuit is preferred in order to reduce the manufacturing cost of the communication controller 100 and to optimize the performance of the communication controller 100.

The memory circuit 102 in the illustrated embodiment includes a boot Read Only Memory (ROM) 120 and a Static Random Access Memory (SRAM) 122. In the illustrated embodiment, the boot ROM 120 is 2 Kbytes in size. Similarly, the SRAM 122 is 256 Kbytes in size. It will be understood that any suitable size memory circuits may be combined to form the memory circuit 102. The respective sizes of the components of the memory circuit 102 may be selected to optimize performance for particular applications of the communication controller 100. Alternatively, different types of memory may be substituted for the boot ROM 120 and the SRAM 122. For example, in one application, the SRAM 122 may be replaced by a flash memory circuit. Other substitutions are well within the purview of those ordinarily skilled in the art and may be made to take advantage of particular operational advantages of a particular memory technology.

The boot ROM 120 stores code for operating the processor 104. In particular, the boot ROM stores code for initializing or booting the processor 104. The SRAM 122 provides additional memory space for operation of the processor 104. Thus, the memory circuit 102 forms a memory block or memory means which stores data and instructions for use or operation by the processor block formed by the processor 104.

The processor 104 in the illustrated embodiment is a circuit block which implements the functionality of a processor circuit such as the industry standard 186 microprocessor. That is, the processor 104 responds to commands and data suitable for a 186-type processor. The microprocessor instruction set is software compatible with the 8086, 8088,80186, 80188 family of microprocessors. An industry standard processor may be preferable because a variety of application programs exist for such processors. Further, use of an industry standard processor allows use of standard compilers and development tools for such a processor. Other microprocessor circuits or processing devices may be substituted. For example, to optimize performance, a reduced instruction set computer (RISC) device may be used. Alternatively, custom logic may be implemented to perform supervisory and control functions for the communication controller 100. The processor may include functional portions such as a central processing unit (CPU) 124 including an arithmetic logic unit, registers, a clock circuit, memory and memory control circuits, etc. In the illustrated embodiment, the processor 104 is implemented as a standard cell selected from a library of operational blocks provided by the manufacturer of the integrated circuit 118 or provided as a VHDL or Verilog IP core from a supplier such as VAutomation, Inc., of Nashua, N.H.

The processor 104 operates in response to data and instructions stored in the memory circuit 102. The processor 104 controls overall operation of the communication controller 100. In addition, the processor may communicate data and other information with external devices using communication resources of the communication controller 100, as will be described below. By means of these communication resources and capabilities, the processor 104 may operate in conjunction with, in subordination to or in supervision of other processing devices on a network.

As can be seen in FIG. 1, one significant alteration has been made to the circuit block forming the processor 104. The address bus used by the processor 104 in the illustrated embodiment is 24 bits wide. The 24 bit address bus is operated in conjunction with a 16 data bit CPU 124. The processor 104 and the memory circuit 102 communicate with other components of the communication controller 100 using the internal bus 130.

Preferably, the processor 104, operating in conjunction with the memory circuit 102, performs one CPU instruction per clock cycle. This is preferred in order to maximize the performance of the communication controller 100. Normally, an 80186 family processor operates with a 48 MHz clock and executes instructions in 4-12 clock cycles per instruction. The preferred processor 104 executes instructions in 1-4 clock cycles per instruction, yielding an effective rate of 192 MHz with a 48 MHz clock. In this embodiment, use of boot ROM 120 or SRAM 122 in place of flash memory or other slower memory may be necessary. For example, the SRAM has an access time of approximately 10 ns. The flash memory, with an access time of 55-70 ns, may be too slow to provide one cycle operation.

The dual port RAM 106 is a dual port random access memory for storing data and instructions. A first port 134 is accessible using the internal bus 130. A second port 136 is accessible from an external connection 138 of the communication controller 100. The external connection 138 may be Input/Output (I/O) pins of the integrated circuit 118. Use of the dual port RAM 136 allows another data source or data destination, such as another processor, to communicate with the communication controller 100 and store data at the communication controller 100. Preferably, the dual port random access memory 106 provides simultaneous reading and writing of data at the same address location. Thus, the dual port RAM 106 can operate as a buffer memory for receiving and transmitting data when the source or destination of the data does not operate at the same data rate as the communication controller 100. In one embodiment, the dual port RAM 106 is functionally compatible with the IDT7005 dual port memory sold by Integrated Device Technology, Inc.

The Ethernet interface 108 is a circuit block which implements the Ethernet data communication standard. Preferably, the Ethernet interface 108 is compatible with the Am79C961 Ethernet controller. In the illustrated embodiment, the Ethernet interface 108 is a media independent interface (MII) suitable for connection to any standard physical (PHY) layer device. That is, another device may be associated with the Ethernet interface 108 in order to form the actual interface. As indicated in FIG. 1, the Ethernet interface 108 may be operated at data rates up to 100 megabits per second. In one embodiment, this is achieved by providing a 5 bit wide data bus 140 operated at 20 megabits per second. Other combinations or partitions may be substituted. Thus, the Ethernet interface 108 forms an Ethernet bus controller.

The first and second CAN interface circuits 110, 112 implement the CAN communication protocol. CAN is a data communication protocol originally developed primarily for automotive applications. However, the protocol has gained wide acceptance and has become an open, international standard. The published standard is conventionally referred to as CAN 2.0B and is the de facto standard for new CAN device designs.

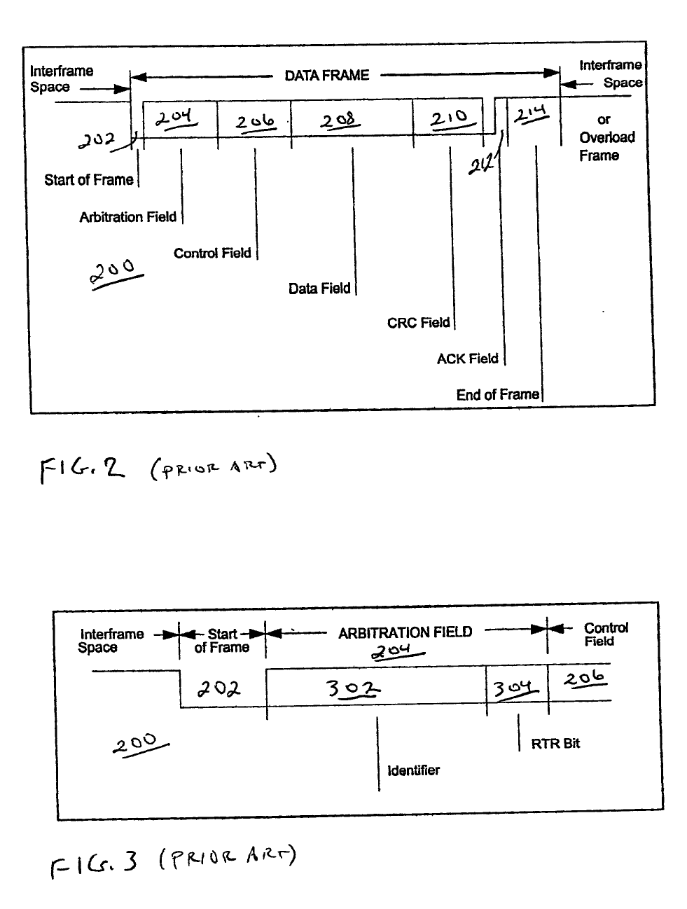

CAN is a serial communication protocol that may be used to transfer up to 8 data bytes within a single message. For larger amounts of data, multiple messages are commonly used. Most CAN-based networks select a single bit rate. The CAN standard supports data transfers between multiple peers. No master controller is needed to supervise network communication. The CAN message is bit-oriented. The message always begins with a “start of message” indication, includes an address called the identifier and may contain data. The message further includes a Cyclical Redundancy Check (CRC) and requires an acknowledgement from all network members. Format of a CAN message will be described in greater detail below in connection with FIGS. 2 and 3.

Each of the CAN interface circuits 110, 112 includes circuitry for implementing the CAN 2.0B standard. In the illustrated embodiment, the two CAN interface circuits 110, 112 are identical. However, in alternative embodiments, a respective CAN interface circuit may be modified to provide particular performance or operational features. Further, external to the communication controller 100, the respective CAN interface circuits 110, 112 may be connected to the same network or may be connected to different networks. In still other applications, only one of the CAN interface circuits 110, 112 may be connected to a network. Each of the CAN interface circuits 110, 112 is coupled to the internal bus 130 for communication with other components of the communication controller 100.

Further, in the illustrated embodiment, each of the CAN interface circuits 110, 112 includes a receive First In, First Out (FIFO) memory 142. The receive FIFO 142 stores messages as they are received by the CAN interface circuit 110 from external to the communication controller 100. Each receive FIFO 142 includes a filter 143 and register 144 in addition to the FIFO memory. The register 144 stores data corresponding to the number of messages stored in the FIFO. The number of messages stored in the register control when the CAN interface circuits 110, 112 generates an interrupt on the internal bus 130 to request processing of the stored messages by the processor 104. This threshold value may be programmed by providing appropriate information to the CAN interface circuits 110, 112. Alternatively, the register may be disabled along with the receive FIFO 142 and the processor 104 can simply poll the CAN interface circuits 110, 112 to obtain receive messages from the interface circuits 110, 112.

The filter 143 is a set of registers that define which bits will be used to allow a message to be put in the FIFO 142 from the CAN bus and registers that define the states of those bits. The filter 143 forms an acceptance filter and includes an acceptance mask register and an acceptance code register. In the preferred embodiment, three acceptance mask register and acceptance code register pairs are included in each CAN interface circuit 110, 112.

The acceptance mask register defines whether the incoming bit from the CAN bus is checked against the acceptance code register. The bits compared include the identifier or arbitration bits and at the sixteen most significant data bits. Any group of bits in the CAN message could be filtered, though. In one embodiment, the incoming bit is checked against the respective acceptance code register. If the incoming bit and the respective acceptance code register are not the same, the message is discarded. In the embodiment including multiple message filters, each message filter can be programmed to filter messages according to predetermined criteria. If a message filter is disabled, that filter will not receive messages.

Restated, for a bit to be filtered, the bit in the acceptance mask register must be a logic 0. The filter will accept that bit when it has the value specified in the acceptance code register. For a CAN message to be accepted, all of the bits that are included in the mask must match the values specified in the acceptance code register. An example follows:

| | | |
|---|---|---|
| Mask register | 0 | -match this bit to value in acceptance code |
| | | register |
| Code register | 1 | |
| Bit on CAN bus | 1 | -match, thus the message is saved in FIFO |
| Bit on CAN bus | 0 | -no match, thus the message is discarded |
| Mask register | 1 | -bit not part of filter |
| Code register | x | (don't care) |

The Serial Peripheral Interface (SPI) circuit 114 operates according to the SPI protocol, which is an industry standard serial communication protocol. Generally, the SPI data interface includes three signals, a clock signal, transmit data and receive data. In one embodiment, the SPI interface circuit 114 includes two shift registers to exchange data between the internal bus 130 and an external port 146.

The ProfiBus interface circuit 116 implements the ProfiBus data communication standard. The ProfiBus interface circuit 116 is preferably a circuit block operable in conjunction with stored data and instructions to implement the ProfiBus standard. The ProfiBus interface circuit 116 is coupled with the internal bus 130 and to an external port 148. In the illustrated embodiment, the ProfiBus interface circuit includes a ProfiBus core which includes hardware and firmware necessary to perform ProfiBus functions. Additional circuit blocks may be included to provide additional functionality for the ProfiBus interface circuit 116.

As illustrated in FIG. 1, the communication controller 100 further includes a Joint Test Action Group (JTAG) interface 150 with in-circuit emulator support for breakpointing and a trace buffer. JTAG is a specification controlling communication of test information from inside a circuit such as the communication controller 100 to outside the device. The JTAG specification specifies data in and data out signals, a clock signal and some commands for controlling the test operation.

An input/output port 151 provides external access to the JTAG circuit 150. JTAG operation gives a 6-line interface to the CPU 124 of the processor 104. The JTAG circuit 150 includes one or more registers for breakpointing along with a memory circuit operating as a trace buffer. The JTAG circuit 150 thus provides direct external connection into the processor 104 for monitoring operation of the processor. However, the added cost is minimal.

The communication controller 100 further includes a chip select circuit 152, timers 154, universal asynchronous receiver-transmitter circuit (UART) 156, direct memory access controller 158, interrupt controller 160 and input/output ports 162. The chip select circuit 152 provides selection of one device for operation on the internal bus 130. Preferably, the chip select circuit 152 is configured to operate in conjunction with the 24-bit address bus used in the internal address bus 130.

The timer circuit 154 includes a plurality of timers to provide software operating the processor 104 with a way to count or time external or internal events. Each timer is preferably equipped with one or more maximum count registers which define a maximum count register the timer will reach. In one embodiments, some timers are configured with two maximum count registers and may be enabled to alternate between the two different registers. The timer circuit 154 may be used to implement a variety of internal timing signals. For example, the timer circuit 154 may generate a fixed time base, such as a 5 ms interval countdown. Other timing signals may be generated as well. Preferably, one timing signal is available at an external connection of the integrated circuit 118 in which the communication controller 100 is embodied.

The Universal Asynchronous Receiver Transmitter circuits (UARTS) 156 preferably include two UART circuits. The UARTS 156 are suitable for communicating using serial data protocols, for example, for controlling a motor drive in a factory application. In one embodiment, the UARTs 156 may be used to form asynchronous serial communication channels including a read port and a write port for full duplex operation. The channels may be fully programmable, including baud rate, stop bits, parity. The receive portion of the serial port provides break character recognition and error detection for frame, parity and overrun errors. Further, the serial port can be programmed to generate interrupts whenever one of these conditions is detected. It may also be programmed to generate interrupts when the next word of data may be sent or when a valid word of data has been received. Both serial port support RTS/CTS (ready to send/clear to send) control signals and direct memory access control, along with baud rates up to 115K baud.

The UARTS 156 may communicate any suitable type of data, including controlling peripheral devices using the RS-232, RS-422 or RS-485 data communication protocols. For example, a device such as a computer terminal may be interfaced with the communication controller using a UART 156. Other examples of communication using RS-232 include a bar code reader, an LED message display, an external printer, etc.

The DMA controller 158 provides control of access to memory such as the memory circuit 102. The DMA controller 158 forces the processor 104 to relinquish control of the data, address and control lines of the bus 130. Thereafter, another device, such as a UART 156, on the Ethernet interface 108 or the ProfiBus interface circuit 116 may then access the memory circuit 102. The DMA controller 158 further provides arbitration functions to ensure that the bus 130 is suitably shared among the components of the communication controller 100.

The interrupt controller 160 controls the processing of interrupts by the processor 104. In the illustrated embodiment, the interrupt controller 160 implements the industry standard 8259-style interrupt controller operation.

The I/O ports 162 provide data access directly to the processor 104. In the illustrated embodiment, the I/O ports 162 are 32 bits wide. Preferably, the I/O ports 162 are configured as parallel data paths which may be programmed bit by bit as input or output ports. Control of the I/O ports 162 is through registers accessible by the processor 104. The I/O ports provide access to four registers within the register set of the CPU 124 of the processor 104. The I/O ports 162 are accessed using the port 138 associated with the dual port RAM 106. That is, the pins of the integrated circuit 118 which provide access to the port RAM 106 are shared with the I/O ports 162.

Thus, it can be seen that the communication controller 100 includes a memory circuit 102 and processor 104 which operates in response to data and instructions stored on the memory circuit 102. The communication controller 100 further includes a first communication circuit for communicating between the communication controller 100 and a first remote device according to the first communication standard. For example, the first communication circuit and first communication standard may be embodied using the Ethernet interface 108, one or more of the CAN interface circuits 110, 112, the SPI circuit 114 or the ProfiBus interface circuit 116. Further, the first communication circuit and first communication standard may be embodied as one of the UARTS 156, for example, communicating using RS-232 with an external device. The Ethernet interface 108, one or more of the CAN interface circuits 110, 112, the SPI circuit 114, ProfiBus interface circuit 116 or the UARTS or equivalent operational blocks or any combination of them forms a first communication means for external communication according to a first standard network communication protocol.

The communication controller 100 also includes a second communication circuit for communicating between the communication controller 100 and a second remote device according to a second data communication standard. Again, the second communication circuit and second data communication standard may be embodied as any one of the Ethernet interface 108, one or both of the CAN interface circuits 110, 112, the SPI circuit 114, the ProfiBus interface circuit 116 or one or more UARTS 156. Any one of these components or equivalents or combination of them forms a second communication means for external communication according to a second standard network communication protocol.

Significantly, in one embodiment, the second communication standard may be different from the first communication standard. Thus, the communication controller may provide a data translation function. For example, data may be received in RS-232 format using one of the UARTS 156. This data may then be provided to another communication circuit such as the Ethernet interface 108 or one of the CAN interface circuits 110, 112, or to the SPI circuit 114 or to the ProfiBus interface circuit 116 for communication to a second remote device according to the appropriate data communication standard. In this manner, the communication controller 100 provides substantial flexibility for the user. Some or all of the components of the communication controller 100 may be utilized while others are left unused. For example, the communication controller 100 may be implemented as a ProfiBus controller including a ProfiBus core, in the form of the ProfiBus interface circuit 116, processor 104 and memory 102, and at least one control circuit which controls wireline data communications according to the standard other than the ProfiBus standard. Examples are the Ethernet interface 108 and CAN interface circuits 110, 112. The internal bus 130 provides internal communications within the communication controller 100 implementing a ProfiBus controller. In this manner, the communication controller 100 operates as a ProfiBus controller with additional function provided by the added communication port.

The communication controller 100 includes program code stored in a first portion of the memory circuit 102, such as the boot ROM 120, and executable by the processor 104. This code controls loading of data and instructions from an external data source by the serial communication port to a second portion of the memory, such as the SRAM 122.

As noted above, the boot ROM 120 is suitable for initializing the processor 104 upon power up or reset. However, the processor 104 will generally require substantially more code and data than the 2 Kbytes provided by the boot ROM 120. Accordingly, the communication controller 100 as illustrated in FIG. 1 provides several possible sources of data for loading the SRAM 122.

Preferably, the code contained in the boot ROM 120 implements a data load procedure for use by the processor 104 in loading additional code in the SRAM 122. In one example, the processor 104 operates responsively to an initialization procedure stored in the boot ROM 120. First, according to this procedure, the processor 104 will look at a serial port on one of the UARTS 156. The UART serial port may be accessed over the internal bus 130. The processor 104 will detect initial characters received at the UART. If the initial characters match a predetermined data pattern, the processor 104 will begin loading the SRAM 122 with serial data from the UART 156. In this manner, the UART may be used for initializing the memory circuit 102.

Secondly, according to this exemplary embodiment, the SRAM 122 may be initialized using an external memory such as flash memory on the system bus external to the communication controller 100. The system bus may be accessed using the port 131 from the processor 104. The processor 104, operating in response to the initialization routine contained in the boot ROM 120, will detect the presence of predetermined data from the external memory. If the predetermined data is present, the processor 104 will begin loading the SRAM using port 131 to access the external memory.

Third, if neither the UARTS 156 nor the external memory provide the initialization data, the processor 104 may look to another source such as the serial peripheral interface circuit 114 for initialization data. An external flash memory or parallel flash may be associated with the port 146 to provide a source of initialization data for the processor 104. It will be understood that other orders may be established for searching for an external source of initialization data. The order described herein is exemplary only.

As noted above, preferably the communication controller 100 is integrated as a single integrated circuit. In one embodiment, the integrated circuit is manufactured using a 0.25 micrometer Complimentary Metal Oxide Semiconductor (CMOS) process provided by Atmel Corporation. A device manufactured according to this process operates with a positive power supply of 2.5 volts, 5 volt tolerant input/output connections and 3.3 volt nominal input/output voltages. Other embodiments may be substituted, as will be understood by those ordinarily skilled in the art. In one exemplary embodiment, the integrated circuit 118 includes a processor block such as processor 104 which controls operation of the integrated circuit, a memory block such as memory circuit 102 which stores data and instructions for use by the processor, and first and second data communication ports such as a bonding pad or pin on an integrated circuit package.

In this exemplary embodiment, the integrated circuit further includes a ProfiBus control block such as ProfiBus controller 116 which is coupled with the first communication port. A CAN control block such as one of the CAN control circuits 110, 112 is coupled with the second communication port. An internal bus couples the processor block, the memory block, the ProfiBus control block and the CAN control block. Other components, including those illustrated in FIG. 1, their functional equivalents and others, may be included in the integrated circuit as well.

Referring now to FIG. 2, it shows format for a CAN message 200. According to the CAN standard, information on the CAN bus is sent in fixed format messages of different but limited length. When the bus is free, any connected unit may start to transmit a new message. The CAN format includes two bit levels, referred to as dominant and recessive.

As shown in FIG. 2, the CAN data frame includes seven different bit fields. The start of frame field 202 marks the beginning of a data frame. It consists of a single dominant bit. A station on the CAN bus is only allowed to start transmission when the bus is idle. All stations on the bus synchronize to the leading edge caused by the starter frame field 202 of the station starting transmission first. The arbitration field 204 consists of an identifier and transmission request (RTR) bit.

FIG. 3 illustrates the arbitration field in greater detail. The identifier 302 has a length of 29 bits in accordance with the CAN 2.0B protocol. Optionally, the identifier may have a length of 11 bits for compatibility with the CAN 1.0 protocol. These bits are transmitted in the order from most significant bit to least significant bit. The RTR bit 304 is dominant in a data frame. In other frames, the RTR bit must be recessive.

Referring again to FIG. 2, the data frame 200 further includes a control field 206. The control field 206 consists of 6 bits. It includes a data length code and two reserved bits. A data field 208 consists of data to be transferred within a data frame. The data field 208 can contain from 0-8 bytes, which each contain 8 bits which are transferred most significant bit first. The CRC field 210 contains a CRC sequence. The CRC sequence is used for error tracking upon receipt of the data frame 200. An acknowledge field 212 is 2 bits long. At a transmitter, the acknowledged field is transmitted with two recessive bits. A receiver which has received a valid message correctly reports this to the transmitter by sending a dominant bit during the first bit of the acknowledged field 212. The data frame 200 lastly includes an end of frame field 214 consisting of seven recessive bits.

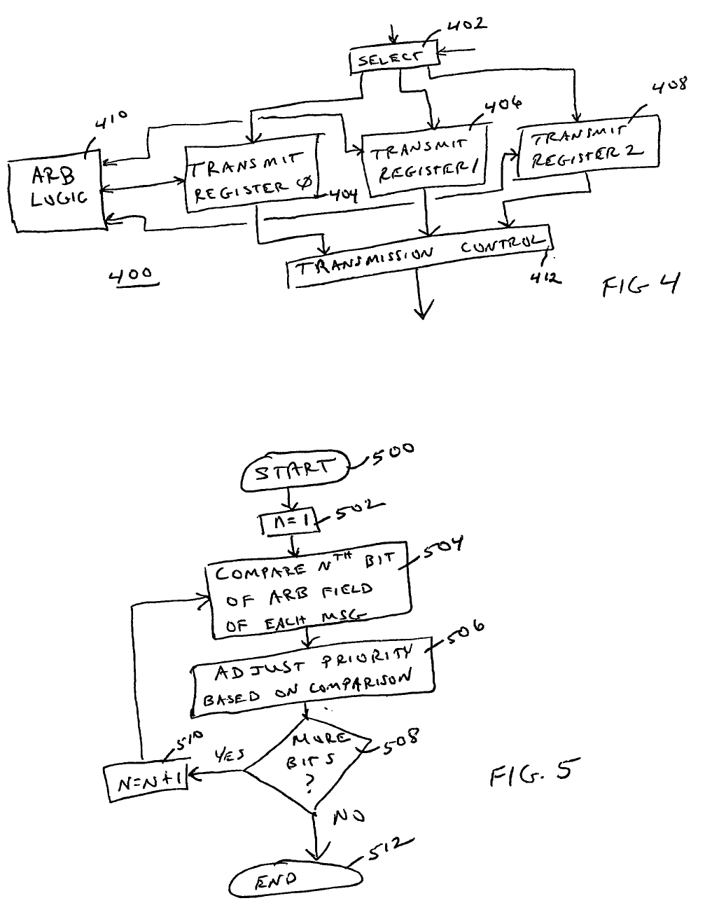

FIG. 4 illustrates a block diagram of a communication circuit 400 for use in the communication controller 100 of FIG. 1. In the illustrated embodiment, the communication circuit 400 is embodied as a Controller Area Network (CAN) bus controller which implements an improved bus arbitration technique in accordance with the standard arbitration requirements illustrated for a CAN message in FIGS. 2 and 3. The communication circuit 400 may form a portion of a CAN communication circuit 110, 112 of the communication controller 100 of FIG. 1 The communication circuit 400 includes a select circuit 402, a plurality of transmit registers including transmit register 404, transmit register 406 and transmit register 408, arbitration logic 410 and a transmission control circuit 412.

Each of the transmit registers 402, 406, 408 is configured to store a respective message for transmission from the CAN bus controller implemented by the communication circuit 400. In the embodiment of FIG. 1, the select circuit 402 is used to direct a CAN message received on the internal bus 130 to one of the transmit registers 404, 406, 408. The arbitration logic 410 is configured to select a respective message for first transmission. The transmission control circuit is coupled to the transmit registers 404, 406, 408 and the arbitration logic 410 and configured to transmit the selected respective message.

The arbitration logic 410 controls arbitration of message transmission. That is, the arbitration logic 410 controls the ordering or priority with which messages are transmitted by the communication circuit 400. After two or more messages are stored in the transmit registers 404, 406, 408, the arbitration logic 410 operates to determine which message should be transmitted in which order.

A method for controlling message transmission from a Controller Area Network (CAN) bus controller to a CAN bus includes comparing a plurality of messages for transmission, determining a priority for transmission of the messages for transmission, and transmitting the messages according to the priority. Preferably, determining the priority for transmission includes determining the priority based on content of the messages for transmission. Determining priority includes performing a bitwise comparison of each message and assigning priority of the messages based on results of the bitwise comparison.

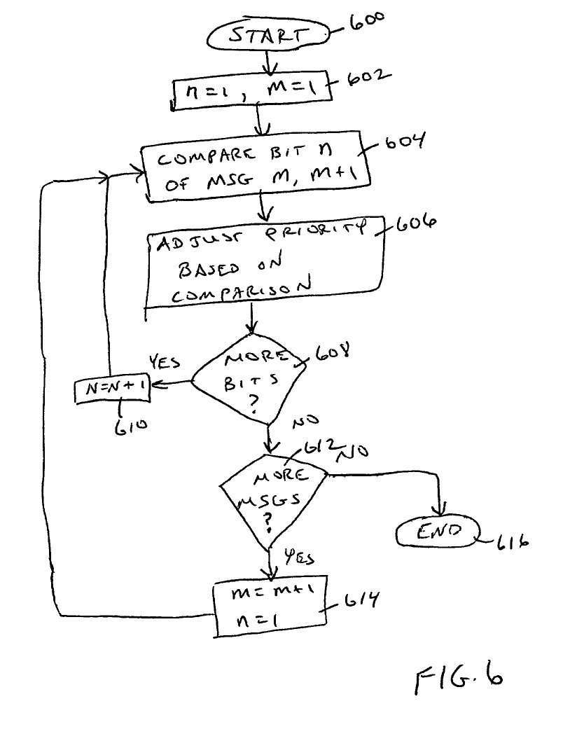

FIG. 5 illustrates a first arbitration technique for use in a CAN controller for controlling message transmission from a CAN bus controller to a CAN bus. The method of FIG. 5 begins at block 500. At block 502, a variable n is initialized to a value 1 or other suitable value.

At block 504, the n-th bit of the arbitration field of each message is compared. At block 506, the priority of transmission for each of the messages is adjusted based on the comparison of block 504. In the context of a CAN bus controller, where a message includes a dominant bit in the n-th bit position, that message will have a higher priority than a message having a recessive bit there. If the n-th bit of both messages have the same state, either dominant or recessive, the messages will have the same priority. At block 508, it is determined if there are more bits in the message or, more specifically, if there are more bits in the arbitration field of each message. If so, at block 510, the bit position n is incremented or otherwise adjusted to analyze the contents of another bit position. Control proceeds to block 504. If there are no more bits in the arbitration field, processing ends at block 512.

FIG. 6 is a flow diagram illustrating an alternative embodiment of a method for controlling message transmission from a CAN bus controller to a CAN bus. Processing begins at block 600. At block 602, variables indicating bit position (n) and message (m) are initialized to a suitable value, such as 1.

At block 604, bit n of each of message m and a next message m+l are compared. Thus, a first and a second message may be selected for arbitration and the first bit position of the arbitration field of each respective message compared. At block 606, priority of message transmission for the two messages is adjusted based on the comparison of block 604. At block 608, it is determined if there are more bits in the arbitration field of the two messages for comparison. If so, at block 610, the bit position index n is incremented or otherwise adjusted to select a next bit position. Control then returns to block 604. If there are no more bits, meaning that the two messages have been fully compared for arbitration and prioritization, control proceeds to block 612. There it is determined if there are more messages for arbitration. If so, at block 614, the message index m is incremented to a next value, such as m+l and the bit indicator is reset to the initial value such as 1. Control then returns to block 604. If, at block 612 there were no more messages for prioritization, control ends at block 616.

As can be seen from the foregoing, the present invention provides an improved communication circuit for controlling communication according to a plurality of data communication standards. A plurality of data communication blocks are combined in a communication controller. Preferably, the data communication blocks are integrated in a common integrated circuit. This level of integration provides optimized data communication performance. More importantly, this level of integration provides minimized product cost. In this manner, a very flexible data communication controller can be provided which can communicate according to any of the plurality of data communication standards.

The data communication controller can provide data translation among different standards in a performance- and cost-efficient manner. The operating memory of the data communication controller can be loaded from a variety of external data sources. Because the operation of the communication controller is so flexible, the communication controller can be manufactured and sold to a wide variety of customers with varying data communication requirements. Thus, the manufacturing cost of the communication controller is minimized by maintaining high volumes of production. Still further, an improved transmission prioritization technique is provided for use in data communication circuits such as CAN bus controllers. A plurality of messages are prioritized within the communication circuit before being presented to the communication bus for further prioritization with other messages on the bus.

While a particular embodiment of the present invention has been shown and described, modifications may be made. It is therefore intended in the appended claims to cover all such changes and modifications which fall within the true spirit and scope of the invention.

We claim:

1. A communication controller comprising:
a memory circuit;
a processor operable in response to data and instructions stored in the memory circuit;
a first communication circuit under control of the processor for communicating between the communication controller and a first remote device according to a first data communication standard; and
a second communication circuit under control of the processor for communicating between the communication controller and a second remote device according to a second data communication standard, the second data communication standard being different from the first data communication standard.

2. The communication controller of claim 1 wherein the memory circuit, the processor, the first communication circuit and the second communication circuit are integrated in a single integrated circuit.

3. The communication controller of claim 1 wherein the first communication circuit comprises a ProfiBus communication circuit.

4. The communication controller of claim 3 wherein the first communication circuit comprises a ProfiBus controller.

5. The communication controller of claim 1 wherein the second communication circuit comprises an Ethernet bus controller.

6. The communication controller of claim 1 wherein the second communication circuit comprises a Controller Area Network (CAN) bus controller.

7. The communication controller of claim 6 wherein the CAN bus controller comprises a logic circuit configured to receive and transmit data according to the CAN standard.

8. The communication controller of claim 6 wherein the second communication circuit comprises two or more a Controller Area Network (CAN) bus controller circuits.

9. The communication controller of claim 1 further comprising an Ethernet bus controller under control of the processor for communicating between the communication controller and a third remote device according to Ethernet data communication standard.

10. The communication controller of claim 1 further comprising an asynchronous serial data communication circuit.

11. The communication controller of claim 10 wherein the CAN bus controller comprises two or more asynchronous serial data communication circuits.

12. The communication controller of claim 9 further comprising an internal communication bus coupled to the processor, the first communication circuit, the second communication circuit and the Ethernet bus controller.

13. The communication controller of claim 1 further comprising a Serial Peripheral Interconnect (SPI) bus controller.

14. The communication controller of claim 1 wherein the memory circuit comprises:
a boot read only memory; and
read-write memory.

15. The communication controller of claim 14 wherein the asynchronous serial data communication circuit comprises:
two or more programmable asynchronous serial data port.

16. A data communication device comprising:
first communication means for external communication according to a first standard network communication protocol;
second communication means for external communication according to a second standard network communication protocol; and
processing means for data processing, the processing means including communication control means for controlling operation of the first communication means and the second communication means.

17. The data communication device of claim 16 wherein the first communication means comprises ProfiBus communication means for external communication according to ProfiBus communication protocol.

18. The data communication device of claim 17 wherein the first communication means comprises a data communication circuit configured to implement one of Controller Area Network (CAN) bus data communication protocol and Ethernet data communication protocol.

19. The data communication device of claim 18 wherein the processing means comprises:
a processor coupled to the first communication means and the second communication means; and
memory means for storing data and instructions for operation by the processor.

20. The data communication device of claim 18 further comprising:
an interface means for serial communication with an external data source for loading at least a portion of the memory means upon initialization of the data communication device.

21. An integrated circuit comprising:
a processor block which controls operation of the integrated circuit;
a memory block which stores data and instructions for use by the processor block;
a first data communication port;
a ProfiBus control block coupled with the first data communication port;
a second data communication port;
a Controller Area Network (CAN) control block coupled with the second data communication port; and
an internal bus coupling the processor block, the memory block the ProfiBus control block and the CAN control block.

22. The integrated circuit of claim 21 further comprising: a second CAN control block coupled to the internal bus.

23. The integrated circuit of claim 21 further comprising:
an Ethernet control block coupled to the internal bus.

24. A ProfiBus controller comprising:
a ProfiBus core;
a processor;
a memory;
at least one control circuit which controls wireline data communications according to a standard other than ProfiBus standard; and
an internal bus for internal data communications within the ProfiBus controller.

25. The ProfiBus controller of claim 24 wherein the at least one control circuit comprises a Controller Area Network (CAN) bus controller.

26. The ProfiBus controller of claim 24 wherein the at least one control circuit comprises two or more Controller Area Network (CAN) bus controllers.

27. The ProfiBus controller of claim 25 wherein the at least one control circuit comprises an Ethernet bus controller.

28. The ProfiBus controller of claim 27 wherein the processor comprises a serial communication port for external data communication.

29. The ProfiBus controller of claim 28 further comprising:
program code stored in a first portion of the memory and executable by the processor for controlling loading of data and instructions from an external data source by the serial communication port to a second portion of memory.
